(19) United States
(12) Patent Application Publication
(10) Pub. No.: US 2021/0154627 A1
(43) Pub. Date: May 27, 2021

(54) FLUID MIXING SYSTEMS AND METHODS TO DYNAMICALLY ADJUST A DENSITY OF A FLUID MIXTURE

(71) Applicant: Halliburton Energy Services, Inc., Houston, TX (US)

(72) Inventors: Andrew Bailey SLOCUM, Houston, TX (US); Megan Lee WALLACE, Houston, TX (US); James OGLE, Livingston, TX (US); Mehdi MAZROOEE, Double Oak, TX (US)

(21) Appl. No.: 16/691,445

(22) Filed: Nov. 21, 2019

(51) Int. Cl. B01F 3/08; E21B 21/06; E21B 41/00; G01F 1/74

(52) U.S. Cl. CPC B01F 3/088; E21B 21/062; B01F 2003/0064; G01F 1/74; B01F 2215/0081; E21B 41/0092

(57) ABSTRACT

Fluid mixing systems and methods to dynamically adjust a density of a fluid mixture are disclosed. A method to dynamically adjust a density of a fluid mixture includes obtaining data indicative of one or more characteristics of a mixture of a first fluid having a first density and a second fluid having a second density that is less than the first density. The method also includes determining, based on the one or more characteristics, an amount of additive to add to the mixture, and releasing a volume of the first fluid, which when mixed with the second fluid, forms a mixture having a ratio of the first fluid to the second fluid. The method further includes mixing the first fluid with the second fluid. The method further includes adding the determined amount of additive to the mixture having the ratio of the first fluid to the second fluid.

The present disclosure relates generally to fluid mixing systems and methods to dynamically adjust the density of a fluid mixture.

Fluids used in injection, hydraulic fracturing, and other well operations often contain multiple types of fluids having different densities. More particularly, a fluid mixture of a fluid having a higher density, such as a spacer fluid, and a second fluid having a lower density, such as water, is sometimes used to perform stimulation treatments, hydraulic fracturing, or other well operations where usage of a fluid or a mixture having a high density improves the results of the respective operations. However, fluids having heavier densities are typically more expensive. As such, the cost associated with a well operation is proportional to the amount of heavier fluids used during the well operation.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 illustrates a schematic, side view of a well during a hydraulic fracturing operation, where a fluid mixing system provides a mixture of fluids used during the injection operation;

FIG. 2A illustrates a system diagram of a fluid mixing system similar to the fluid mixing system of FIG. 1;

FIG. 2B illustrates a system diagram of another fluid mixing system similar to the fluid mixing system of FIG. 2A;

FIG. 2C illustrates a system diagram of another fluid mixing system similar to the fluid mixing system of FIG. 2B;

FIG. 3 illustrates a block diagram of the fluid mixing system of FIG. 2A; and

FIG. 4 illustrates a flow chart of a process to dynamically adjust a density of a fluid mixture.

The illustrated figures are only exemplary and are not intended to assert or imply any limitation with regard to the environment, architecture, design, or process in which different embodiments may be implemented.

### DETAILED DESCRIPTION OF ILLUSTRATIVE EMBODIMENTS

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The present disclosure relates to fluid mixing systems and methods to dynamically adjust a density of a fluid mixture. The fluid mixing system is configured to mix a first fluid having a first density with a second fluid having a second density that is less than the first density. As referred to herein, a fluid mixture refers to a mixture of two or more types of fluids. In some embodiments, a fluid mixture also includes solid particles and is referred to as a slurry. The fluid mixing system has one or more processors that are operable to determine an amount of additive to add to the fluid mixture to form a slurry based on characteristics of the fluid mixture and operating parameters for operating the fluid mixing system. As referred to herein, characteristics of the fluid mixture includes physical and chemical characteristics of the fluid mixture, physical and chemical characteristics of individual fluids that form the fluid mixture, and physical and chemical characteristics of a slurry that contains solid particles added to the fluid mixture. Examples of characteristics of the fluid mixture include, but are not limited to, the density of a fluid of the fluid mixture, the flow rate of the fluid of the fluid mixture, the volume of the fluid of the fluid mixture, the density of the fluid mixture, the flow rate of the fluid mixture, the volume of the mixture, the density of the slurry, the flow rate of the slurry, as well as other physical and chemical characteristics of the fluid mixture, individual fluids of the fluid mixture, and the slurry. Further, and as referred to herein, an additive is any solid particle or liquid that would increase the density of a fluid mixture when added to the fluid mixture, or would reduce the ratio of the concentration of one fluid to the concentration of another fluid of the fluid mixture while maintaining the density of the fluid mixture. Examples of additives include, but are not limited to, NaBr, CaCl2, CaBr2, ZnBr2, KCl, NaCl, Potassium Formate, seawater, Cesium Formate, Calcium Carbonate, brine, one or more types of proppants used in a well operation, and other types of solid particles or liquids mixed with solid particles, that when added to a fluid mixture, increase the density of the fluid mixture or reduce the ratio of the concentration of one fluid to another fluid of the fluid mixture while maintaining the density of the fluid mixture.

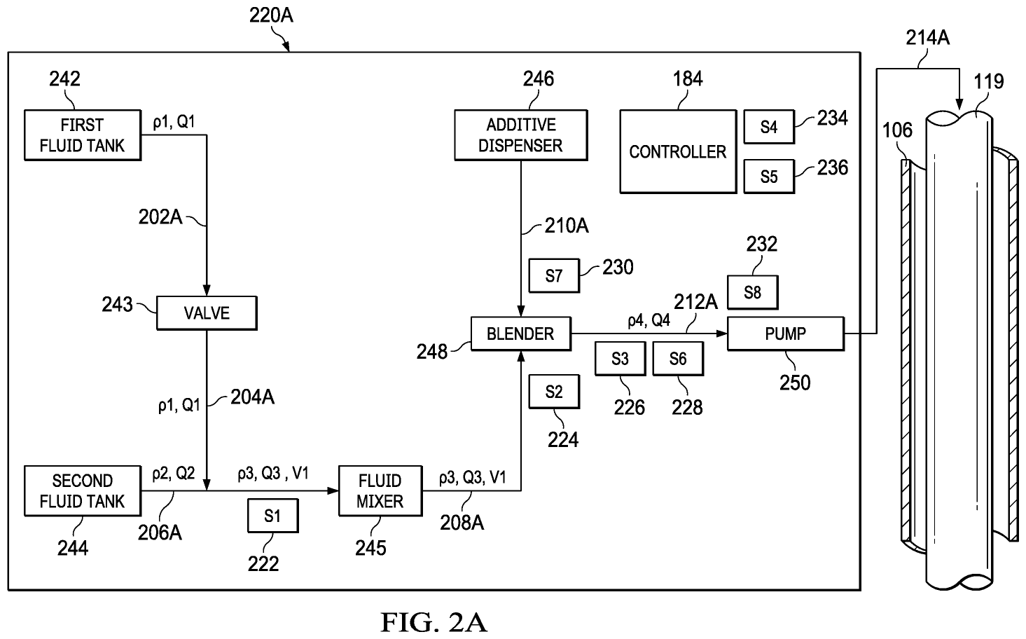

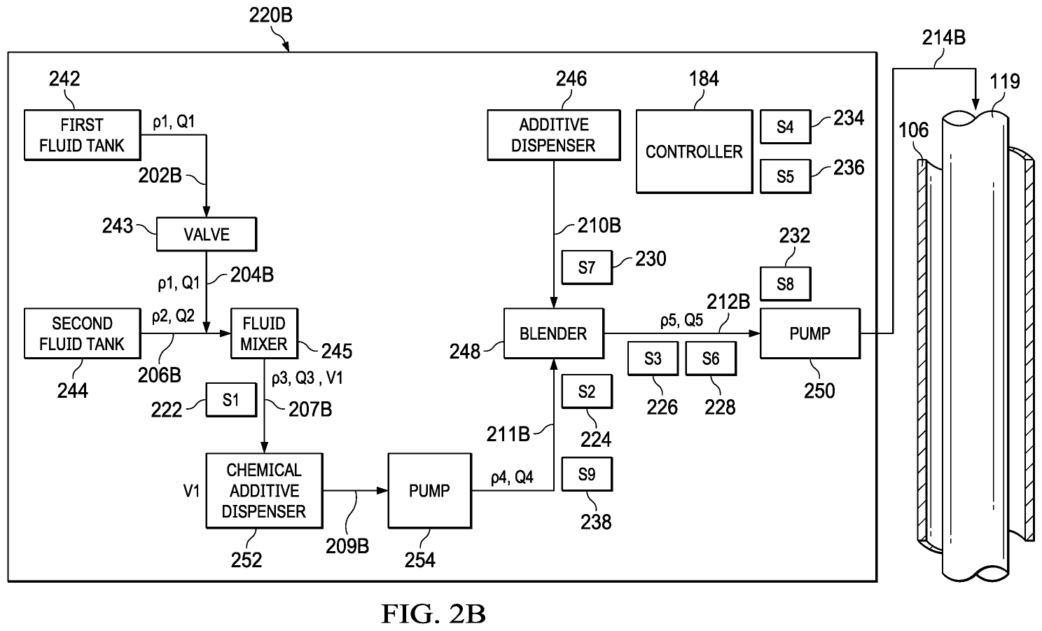

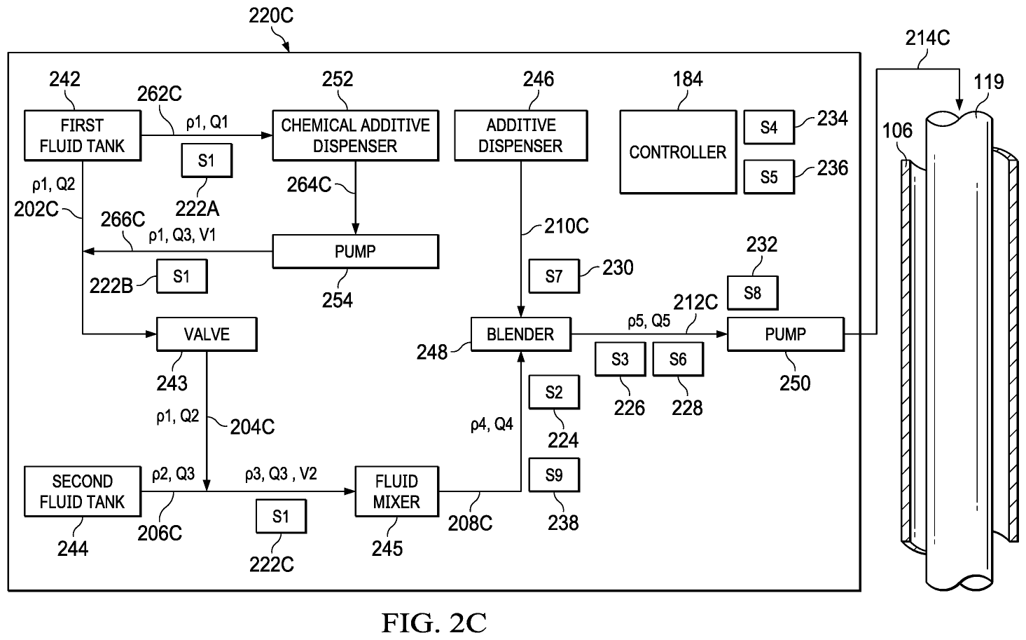

In some embodiments, the fluid mixing system includes sensors that monitor characteristics of the fluid mixture and parameters of the well operation. In one or more of such embodiments, the fluid mixing system includes flowmeters configured to monitor the flow rate of the fluid mixture and individual fluids that form the fluid mixture. Additional descriptions of sensors of the fluid mixing system are provided in the paragraphs below and are illustrated in at least FIGS. 2A-2C.

In some embodiments, the fluid mixing system also determines the amount of additive to add to the mixture based on one or more operating parameters. As referred to herein, an operating parameter is any parameter that defines how to operate the fluid mixing system as well as other tools and components used in a well operation while the fluid mixing system is in operation. Examples of operating parameters include, but are not limited to, parameters that define how to operate sensors, mixers, blenders, additive dispensers, valves, pumps and other components of the fluid mixing system, a desired flow rate or range of flow rates of the slurry or fluid mixture, a desired density or density range of the slurry or fluid mixture, operating parameters that comply with safety considerations, as well as other operating parameters described herein. The one or more processors determine the amount of the first fluid to mix with the second fluid based on the amount of additive to add to the mixture, and control one or more valves to release the determined amount of the first fluid to mix with the second fluid. In some embodiments, the fluid mixing system includes a proportional valve. In one or more of such embodiments, the one or more processors configure or request the proportional valve to release the determined amount of the first fluid to mix with the second fluid.

In some embodiments, the fluid mixing system includes a mixing tool, such as a static mixer. In one or more of such embodiments, the processors configure or request the mixing tool to mix the first fluid and the second fluid to form a fluid mixture. In some embodiments, the fluid mixing system has an additive dispenser that is configured to release the determined amount of additive to add to the mixture. In one or more of such embodiments, the one or more processors configure or request the additive dispenser to release the determined amount of additive to the mixture. In some embodiments, the fluid mixing system includes a blending tool, such as a blender, that is configured to mix the additive with the fluid mixture to form a slurry. In one or more of such embodiments, the one or more processors configure or request the blending tool to mix the fluid mixture and the additive to form a slurry. In some embodiments, the fluid mixing system includes a pump that is configured to pump the slurry downhole. In one or more of such embodiments, the one or more processors configure or request the pump to pump the slurry downhole at a predetermined rate that is based on one or more characteristics of the mixture or one or more operating parameters.

While the wellbore mixing system is in operation, the wellbore mixing system continuously or periodically monitors one or more characteristics of the fluid mixture and determines whether the fluid mixing system should readjust the ratio of the first fluid to the second fluid in the mixture, or the amount of additive to add to the mixture based on the one or more characteristics of the fluid mixture. In some embodiments, the one or more processors assess data indicative of the one or more characteristics of the fluid mixture (e.g., flow rate of the mixture, the slurry, density of the mixture, the slurry, etc.), and dynamically adjust subsequent operations based on data indicative of the one or more characteristics. In one or more of such embodiments, the fluid mixing system continuously or periodically determines one or more characteristics of a slurry, then continuously or periodically adjusts the amount of the first fluid that is mixed with the second fluid (the ratio of the first fluid to the mixture) based on the amount of additive in the slurry. In one or more of such embodiments, after a fluid mixture is mixed with a determined amount of additive to form a slurry, the one or more processors analyze data indicative of the flow rate and density of the slurry to determine a new ratio of the first fluid to the second fluid (or the first fluid to the mixture) that would form a fluid mixture with desirable characteristics (e.g., faster flow rate, higher density), or with characteristics that comply with one or more operating parameters (e.g., a slurry that is within a threshold density range). The one or more processors then configure or request a valve to release an amount of the first fluid which, when mixed with the second fluid, forms a mixture having the determined ratio of the first fluid to the second fluid.

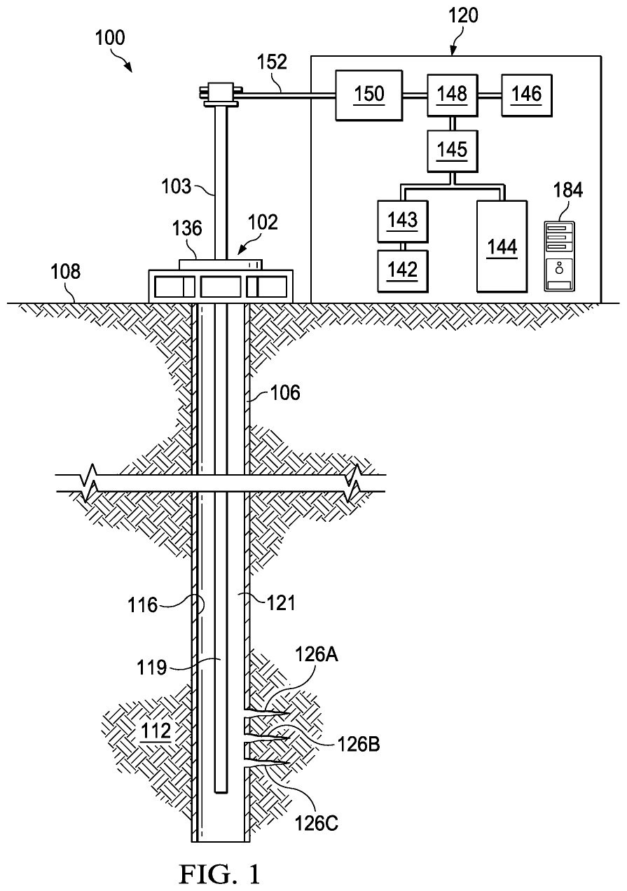

In one or more of such embodiments, the fluid mixing system continuously or periodically determines one or more characteristics of a fluid mixture, then continuously or periodically adjusts the amount of additive to add to the fluid mixture based on the ratio of the first fluid to the second fluid. In one or more embodiments, after the fluid mixture having the determined ratio of the first fluid and the second fluid is formed, the one or more processors analyze data indicative of the flow rate and the density of the fluid mixture to determine a new amount of additive to add to the fluid mixture that would form a slurry with desirable characteristics (e.g., lower flow rate, lower density, a desired ratio of the first fluid to the second fluid, etc.), or with characteristics that comply with one or more operating parameters (e.g., a slurry that is within a threshold density range). Additional descriptions of fluid mixing systems and methods to dynamically adjust a density of a fluid mixture are provided in the paragraphs below and are illustrated in at least FIGS. 1-4.

Now turning to the figures, FIG. 1 illustrates a side view of a well environment 100, where a fluid mixing system 120 provides a mixture of fluids used during a hydraulic fracturing operation. In the embodiment of FIG. 1, wellbore 106 extends from a surface 108 of well 102 to or through a formation 112. A casing 116 is deployed along the wellbore 106 to insulate downhole tools and strings deployed in the casing 116, to provide a path for hydrocarbon resources flowing from the subterranean formation 112, to prevent cave-ins, and/or to prevent contamination of the subterranean formation 112. Casing 116 is sometimes surrounded by a cement sheath (not shown), which is deposited in an annulus between the casing 116 and the wellbore 106 to fixedly secure the casing 116 to the wellbore 106 and to form a barrier that isolates the casing 116. Although not depicted, there may be layers of casing concentrically placed in the wellbore 106, each having a layer of cement or the like deposited thereabout.

A conveyance 119 is positioned proximate to well 102. Conveyance 119 is lowered down the wellbore 106, i.e. downhole. In one or more embodiments, the conveyance 119 is lowered downhole through a blowout preventer 103 and a wellhead 136. In the illustrated embodiment of FIG. 1, conveyance 119 is a tubular. In one or more embodiments, conveyance 119 may be coiled tubing, drill pipe, production tubing, or another type of conveyance that has an inner diameter that forms a fluid flow path for fluids to flow downhole. In one or more embodiments, conveyance 119 also transmits signals including, but not limited to, downhole properties and fluid properties of fluids flowing downhole. In one or more embodiments, conveyance 119 also provides power to downhole components. In one or more embodiments, conveyance 119 also provides downhole telemetry to downhole tools and sensors that are deployed downhole. Additional descriptions of telemetry are provided in the paragraphs below. In one or more embodiments, conveyance 119 also provides a combination of power and downhole telemetry to downhole tools and sensors that are deployed downhole. For example, where the conveyance 119 is a coiled tubing (including electro-coiled-tubing), or drill pipe, power and data are transmitted along conveyance 119 to the downhole tools and transmit data from downhole sensors.

Conveyance 119 is fluidly coupled to fluid mixing system 120 via inlet conduit 152, which provides a fluid flow path from fluid mixing system 120 to conveyance 119. Fluids flow through conveyance 119 downhole, and into an annular region 121 between conveyance 119 and casing 116. In some embodiments, annular region 121 is isolated from other annular regions by one or more isolation devices (not shown). In the illustrated embodiment, perforations 126A-126C are formed in annular region 121. Fluids flowing into annular region 121 flow through perforations 126A-126C into formation 112. In some embodiments, some of the fluids that flow into annular region 121 flow through a return annulus (not shown) uphole, where the fluids are reused during another well operation. In some embodiments, some of the fluids flow uphole through conveyance 119 or another conveyance (not shown) that is deployed in wellbore 106.

Fluid mixing system 120 includes a first fluid tank 142 that stores a first fluid (e.g., a spacer fluid) and a second fluid tank 144 that stores a second fluid (e.g., carrier fluid) having a density that is less than the density of the first fluid. First fluid tank 142 is fluidly coupled to a valve 143 that controls the ratio of the first fluid that is released relative to the second fluid. In some one or more embodiments, valve 143 is a proportional valve that determines the ratio of the first fluid to the second fluid based on one or more operations described herein. The determined ratio of the first fluid and the second fluid are released and are mixed into a mixture by fluid mixer 145. In some embodiments, fluid mixer 145 is a static mixer. As referred to herein, a mixer is any tool or component configured to mix two or more types of fluids into a heterogeneous or a homogeneous fluid mixture.

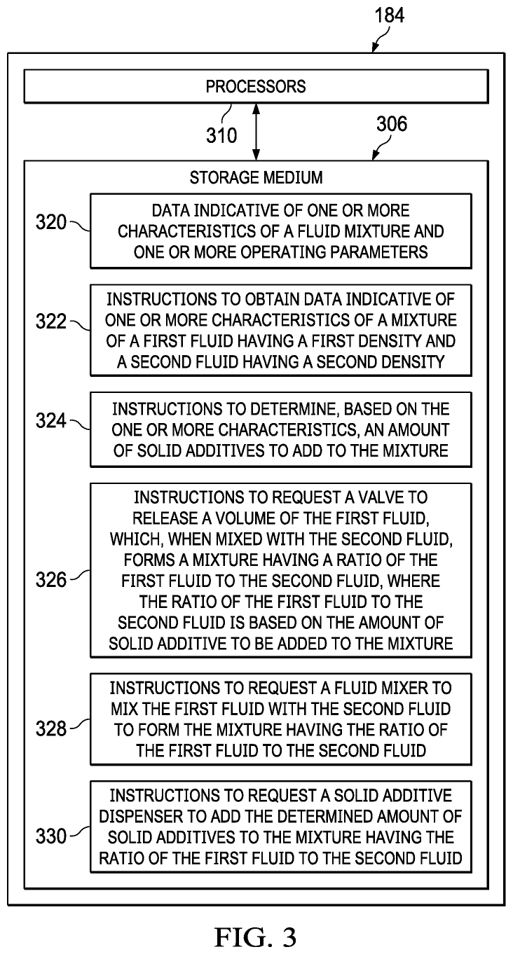

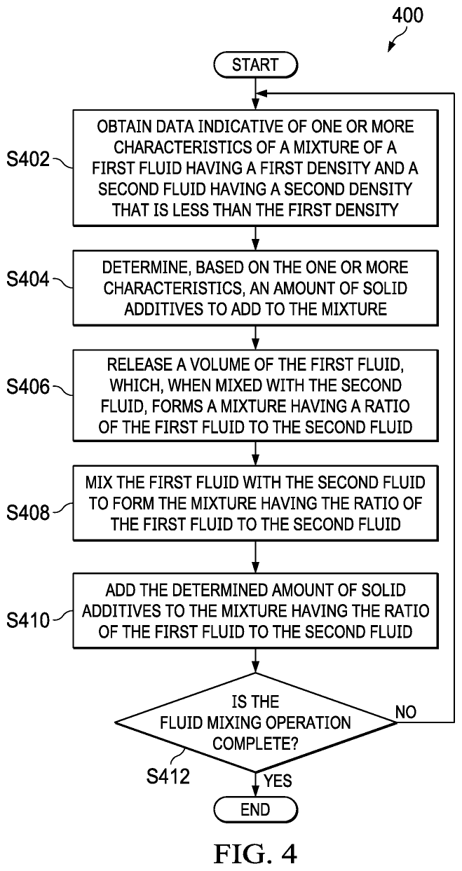

Fluid mixing system 120 also includes an additive dispenser 146 that is configured to dispense varying amounts and types of additives to add to the fluid mixture. Further, fluid mixing system 120 also includes a blender 148 that blends the dispensed additive with the fluid mixture to form a slurry. Fluid mixing system 120 also includes a pump 150 that pumps the slurry through inlet conduit 152 into conveyance 119, where the slurry travels down conveyance 119, into annular region 121, and eventually through perforations 126A-126C into formation 112. Fluid mixing system 120 also includes sensors (shown in FIGS. 2A-2C) that measure characteristics of the fluids, the fluid mixture, the slurry, and operating parameters described herein. Further, fluid mixing system 120 also includes a controller 184 that has processors configured to obtain data indicative of characteristics of the fluids, the fluid mixture, the slurry, and operating parameters described herein. In some embodiments, the processors of fluid mixing system 120 continuously determine and vary, based on the obtained data, the amount of additive to add to the fluid mixture and the ratio of the concentration of the first fluid and the second fluid. Additional operations performed by controller 184 are provided in the paragraphs below and are illustrated in at least FIGS. 3 and 4.

Although FIG. 1 illustrates an on-shore hydraulic fracturing environment, fluid mixing system 120 is also deployable in off-shore hydraulic fracturing environments, on-shore and off-shore injection environments, as well as during other types of well operations where additive is added to a fluid mixture having two or more types of fluids to increase the density of the fluid mixture or to reduce the ratio of the concentration of one fluid of the fluid mixture to the concentration of another fluid of the fluid mixture. Further, although FIG. 1 illustrates a single fluid mixing system 120, in some embodiments, multiple fluid mixing systems (not shown) are simultaneously deployed near wellbore 106. Further, although fluid mixing system 120 of FIG. 1 has two fluid tanks, in some embodiments, fluid mixing system 120 has additional fluid tanks having additional types of fluids. Further, although FIG. 1 illustrates a cased-hole environment, fluid mixing system 120 is also deployable in an open-hole environment. Additional descriptions of mixing three or more types of fluids are provided in the paragraphs below.

FIG. 2A illustrates a system diagram of a fluid mixing system 220A similar to the fluid mixing system 120 of FIG. 1. Block 242 represents a first fluid tank that stores a first fluid and block 244 represents a second fluid tank that stores a second fluid. The first fluid flows from first fluid tank 242 along a fluid flow path 202A into a proportional valve 243. Controller 184 determines a fluid mixture having a desired ratio of the first fluid to the second fluid, and a volume of the first fluid, which when mixed with the second fluid, forms a mixture having the ratio of the first fluid to the second fluid. In some embodiments, controller 184 determines the ratio of the first fluid to the second fluid based on the amount of additive to add to the fluid mixture. Additional operations performed by controller 184 to determine the ratio of the first fluid to the second fluid are provided herein. Controller 184 requests proportional valve 243, or a processor of proportional valve 243 to release the determined volume of the first fluid. The first fluid then flows along a fluid flow path 204A and is mixed with the second fluid, which is flowing along fluid flow path 206A.

In the illustrated embodiment of FIG. 2A, fluid mixing system 220A has a sensor 222 positioned near fluid flow path 206A to measure the flow rate of the first fluid and the second fluid and the density of the first fluid and the second fluid. In some embodiments, fluid mixing system 220A also has additional sensors placed near fluid flow paths 202A and 206A to individually measure the flow rate of the first fluid and the second fluid, respectively. Fluid mixing system 220A has a fluid mixer 245 that mixes the first fluid and the second fluid into a fluid mixture having the determined ratio of the first fluid to the second fluid. In some embodiments, controller 184 requests fluid mixer 245 or a processor of fluid mixer 245 to mix the first fluid and the second fluid into a homogeneous fluid mixture or a mixture having one or more determined characteristics of the mixture. The fluid mixture flows along a fluid flow path 208A towards a blender 248. In the illustrated embodiment of FIG. 2A, fluid mixing system 220A also has a sensor 224 positioned near fluid flow path 208A to measure the flow rate and the density of the fluid mixture.

Fluid mixing system 220A has an additive dispenser 246 that dispenses one or more types of additives. Controller 184 determines, based on one or more characteristics of the fluid mixture, a type and an amount of an additive to release and requests additive dispenser 246 to release the type and amount of the additive. In some embodiments, controller 184 requests additive dispenser 246 to simultaneously release multiple types of additives. In some embodiments, controller 184 continuously or periodically requests additive dispenser 246 to vary the amount and type of an additive to add to the fluid mixture. Additional operations performed by controller 184 to determine the type and amount of additive is provided herein. The released additive travels along fluid flow path 210A towards blender 248. In the illustrated embodiment of FIG. 2A, fluid mixing system 220A also has a sensor 230 positioned near fluid flow path 210A to measure the rate at which an additive is dispensed as well as other characteristics of the dispensed additive. In the illustrated embodiment of FIG. 2A, fluid mixing system 220A also has sensors 226 and 228 positioned near fluid flow path 212A to measure the density and the flow rate of the slurry, respectively. In some embodiments, sensors 226 and 228 are configured to measure additional characteristics of the slurry. Blender 248 blends the additive and the fluid mixture to form a slurry. The slurry flows along fluid flow path 212A to pump 250.

Controller 184 determines a pump rate of pump 250 to pump the slurry downhole and requests pump 250 to operate at the determined pump rate to pump the slurry to flow along fluid flow path 214A into conveyance 119, where the slurry eventually flows out of conveyance 119 and into an annular region of wellbore 106. In some embodiments, controller 184 determines the pump rate of pump 250 based on one or more downhole characteristics, such as the pressure of the wellbore, the pressure of the annular region, the temperature of the wellbore, presence of other fluids as well as other measurement characteristics of the wellbore. In the illustrated embodiment of FIG. 2A, fluid mixing system 220A also has sensors 234 and 236 positioned along conveyance to measure the pressure of the annulus and the treating pressure, respectively. In some embodiments, treating pressure is the surface pressure on conveyance 119. In some embodiments, sensors 234 and 236 are placed on the rig on surface iron, and are configured to measure pressures from conveyance 119 and an annular region between conveyance 119 and wellbore 106. In some embodiments, the bottom hole treating pressure is calculated from measurements obtained from sensors 234 and 236. In some embodiments, fluid mixing system 220A has additional sensors positioned at other downhole locations to measure downhole characteristics and to provide data indicative of downhole characteristics via telemetry to controller 184. In the illustrated embodiment of FIG. 2A, fluid mixing system 220A also has a sensor 232 positioned near pump 250 to measure the pump rate of pump 250 and pressure generated by pump 250, and other properties of the slurry after the slurry is pumped by pump 250. In some embodiments, a flow restrictor (e.g., a check valve) is coupled to conveyance 119 to prevent dissipation of pressure back into fluid mixing system 220A.

In some embodiments, fluid mixing system 220A mixes three or more types of fluids into a fluid mixture. In one or more of such embodiments, after fluid mixer 245 mixes the first fluid and the second fluid into a fluid mixture of the first fluid and the second fluid, the fluid mixture is then mixed with a third fluid flowing from a third fluid tank (not shown), and is mixed again (by fluid mixer 245 or by another mixer (not shown)) to form a second fluid mixture having all three fluids. The second fluid mixer then flows along fluid flow path 208A or another fluid flow path (not shown) to blender 248. In one or more of such embodiments, controller 184 determines a desired ratio of the first fluid to the second fluid to the third fluid, and requests another valve (not shown) to disperse a volume of the fluid mixture containing the first fluid and the second fluid, which when mixed with the third fluid, would form the second mixture having the desired ratio of the first fluid to the second fluid to the third fluid.

While fluid mixing system 220A is in operation, sensors 222, 224, 226, 228, 230, 232, 234, and 236 continuously or periodically provide feedback of measurements obtained by the respective sensors to controller 184. Controller 184, continuously or periodically determines whether to vary the amount and type of additive to add or the ratio of the first fluid and the second fluid based on up-to-date measurements obtained by the respective sensors. In some embodiments, controller 184 adjusts the ratio of the first fluid to the second fluid and the amount of slurry added to the fluid mixture based on the up-to-date measurements. In some embodiments, controller 184 periodically determines the flow rate of the mixture, the ratio of the first fluid to the second fluid, the density of the mixture, the flow rate of the slurry, the density of the slurry, and downhole properties, and dynamically makes adjustments to the amount and type of additive to add to the mixture based on the foregoing characteristics or changes to the foregoing characteristics. In some embodiments, controller 184 periodically determines one or more safety parameters or operating parameters, or changes to one or more safety parameters or operating parameters associated with the first fluid, the second fluid, the mixture, the slurry, downhole conditions, and the well operation, and dynamically makes adjustments to the amount and type of additive to add to the mixture based on the foregoing safety parameters or operating parameters, or changes to the safety parameters or operating parameters. In some embodiments, controller 184 periodically analyzes measurements obtained from one or more sensors (e.g. sensors 232, 234, and 236) to adjust one or more fluid properties of the fluid mixture and slurry. In one or more of such embodiments, controller 184 determines whether the fluid pressure at any point along the fluid flow paths is greater than a threshold value, where a fluid pressure above the threshold value potentially damages equipment and systems used to perform operations described herein. In one or more of such embodiments, controller 184, upon determining that the fluid pressure is greater than the threshold, reduces the amount pump rate of pump 250. In one or more of such embodiments, controller 184, upon determining that the fluid pressure is greater than the threshold, reduces the density of fluid mixture or the slurry. Although FIG. 2A illustrates eight sensors, in some embodiments, fluid mixing system 220A utilizes a different number of sensors to obtain measurements used for operations described herein.

FIG. 2B illustrates a system diagram of another fluid mixing system 220B similar to the fluid mixing system 220A of FIG. 2A. First fluid tank 242, second fluid tank 244, valve 243, fluid mixer 245, additive dispenser 246, blender 248, pump 250 and sensors 222, 224, 226, 228, 230, 232, 234, and 236 of FIG. 2B are similar to first fluid tank 242, second fluid tank 244, valve 243, fluid mixer 245, additive dispenser 246, blender 248, pump 250 and sensors 222, 224, 226, 228, 230, 232, 234, and 236 of FIG. 2A, which are described herein. Further, fluid flow paths 202B, 204B, 206B, 212B, 214B, and flow path 210B, are similar to fluid flow paths 202A, 204A, 206A, 212A, 214A, and flow path 210A, of FIG. 2A, which are described herein.

In the illustrated embodiment of FIG. 2B, after mixer 245 mixes the first fluid and the second fluid to form a fluid mixture, the fluid mixture flows along fluid flow path 207B to chemical additive dispenser 252. As referred to herein, a chemical dispenser is a dispenser operable to dispense one or more types of chemical agents into a fluid. Examples of chemical agents include, but are not limited to, Guar, Hydroxyl Propyl Guar, CaboxyMethyl Hydroxy Propyl Guar, Guar Derivitives, polyacrylimides, pH control agents, acids, basses, Surfactants, detergents, borate crosslinkers, zirconate crosslinkers, breakers, gel stabilizers, formation consolidation agents, and resins. Controller 184 determines, based on one or more characteristics of the fluid mixture, a type and an amount of chemical additive to release and requests chemical additive dispenser 252 to release the type and amount of the chemical additives. In some embodiments, controller 184 requests chemical additive dispenser 252 to simultaneously release multiple types of chemical additives. In some embodiments, controller 184 continuously or periodically requests chemical additive dispenser 252 to vary the amount and type of chemical additive to add to the fluid mixture. The fluid mixture containing the chemical additive flows along fluid flow path 209B to pump 254, which pumps the mixture along fluid flow path 211B to blender 248. In the embodiment of FIG. 2B, fluid mixing system 220B also includes sensor 238 that measures the flow ratedensity of the mixture containing the chemical additive. In some embodiments, a chemical sensor (not shown) configured to measure one or more chemical properties of the added chemical additive is also positioned near sensor 238.

FIG. 2C illustrates a system diagram of another fluid mixing system 220C similar to the fluid mixing system 220B of FIG. 2B. First fluid tank 242, second fluid tank 244, valve 243, fluid mixer 245, additive dispenser 246, blender 248, pump 250, chemical additive dispenser 252, pump 254, and sensors 224, 226, 228, 230, 232, 234, 236, and 238 of FIG. 2C are similar to first fluid tank 242, second fluid tank 244, valve 243, fluid mixer 245, additive dispenser 246, blender 248, pump 250, chemical additive dispenser 252, pump 254, and sensors 224, 226, 228, 230, 232, 234, 236, and 238 of FIG. 2B, which are described herein. Further, fluid flow paths 202C, 204C, 206C, 208C, 212C, 214C, and flow path 210C, are similar to fluid flow paths 202A, 204A, 206A, 208A, 212A, 214A, and flow path 210A, of FIG. 2A, which are described herein.

In the embodiment of FIG. 2C, first fluid flows from first fluid tank 242 along fluid flow path 262C to chemical additive dispenser 252. Controller 184 determines, based on one or more characteristics of the first fluid, the second fluid, or the fluid mixture, a type and an amount of chemical additive to release and requests chemical additive dispenser 252 to release the type and amount of the chemical additive. In some embodiments, controller 184 requests chemical additive dispenser 252 to simultaneously release multiple types of chemical additives. In some embodiments, controller 184 continuously or periodically requests chemical additive dispenser 252 to vary the amount and type of chemical additive to add to the first fluid. The first fluid containing the chemical additive flows along fluid flow path 264C to pump 254, which pumps the first fluid along fluid flow paths 266C to valve 243. In the embodiment of FIG. 2C, fluid mixing system 220C has three sensors 222A, 222B, and 222C positioned along fluid flow paths 262A, 262B, and 262C, respectively, to measure the flow rate and density of the first fluid (without and with chemical additive) as the first fluid flows along fluid flow paths 262A, 262B, and 262C, respectively.

FIG. 3 is a block diagram of a controller 184 of FIG. 1. Controller 184 includes a storage medium 306 and processors 310. Storage medium 306 may be formed from data storage components such as, but not limited to, read-only memory (ROM), random access memory (RAM), flash memory, magnetic hard drives, solid-state hard drives, CD-ROM drives, DVD drives, floppy disk drives, as well as other types of data storage components and devices. In some embodiments, storage medium 306 includes multiple data storage devices. In further embodiments, the multiple data storage devices may be physically stored at different locations. Data indicative of one or more characteristics of a fluid mixture and one or more operating parameters are stored at a first location 320 of storage medium 306.

As shown in FIG. 3, instructions to obtain data indicative of one or more characteristics of a mixture of a first fluid having a first density and a second fluid having a second density are stored at a second location 322 of storage medium 306. Further, instructions to determine, based on the one or more characteristics, an amount of additive to add to the mixture are stored at a third location 324 of the storage medium 306. Further, instructions to request a valve to release a volume of the first fluid, which when mixed with the second fluid, forms a mixture having a ratio of the first fluid to the second fluid are stored at a fourth location 326 of storage medium 306. Further, instructions to request a fluid mixer to mix the first fluid with the second fluid to form the mixture having the ratio of the first fluid to the second fluid are stored at a fifth location 328 of storage medium 306. Further, instructions to request an additive dispenser to add the determined amount of additive to the mixture having the ratio of the first fluid to the second fluid are stored at a sixth location 330 of storage medium 306. Additional instructions to perform operations described herein are also stored in storage medium 306.

In some embodiments, controller 184 is a component of another component or tool of the fluid mixing systems described herein. For example, where controller 184 is a component of additive dispenser 246 of FIGS. 2A-2C, one or more processors of controller 184 operates additive dispenser 246 to dispense the determined amount of additive. In some embodiments, controller 184 has multiple processors that are onboard components of other components of the fluid mixing system. For example, where controller 184 has processors that are onboard components of first fluid tank 242, second fluid tank 244, valve 243, fluid mixer 245, additive dispenser 246, blender 248, and pump 250 of FIGS. 2A-2C, the onboard processors of each component operates each respective component to perform operations described herein.

FIG. 4 is a flow chart of a process 400 to dynamically adjust a density of a fluid mixture of a well operation. Although the operations in the process 400 are shown in a particular sequence, certain operations may be performed in different sequences or at the same time where feasible. Further, although the operations in process 400 are described to be performed by processors 310 of controller 184 of FIG. 3, the operations may also be performed by one or more processors of other electronic devices operable to perform operations described herein.

At block S402, data indicative of one or more characteristics of a mixture of a first fluid having a first density and a second fluid having a second density that is less than the first density are obtained. FIG. 2A, for example, illustrates sensors 222, 224, 226, 228, 230, 232, 234, and 246 positioned near different fluid flow paths, and along conveyance 119 to obtain measurements indicative of the fluid flow rate and density of the first fluid, the fluid flow rate and density of the second fluid, the fluid flow rate and density of the fluid mixture, properties of the additive, fluid flow rate and density of the slurry, properties of conveyance 119 and wellbore 106, as well as other characteristics of the first fluid, the second fluid, the fluid mixture, the slurry, downhole properties, and operational parameters.

In some embodiments, the flow of the first fluid and the second fluid are determined by solving the following equations:

$$\begin{matrix}{Q}_{1} = IF [ \frac{BHTP + Friction - Max Treating Pressure Desired}{0.05195 \times TVD} \times ( 1 + AVF \times PPAG ) - PPAG < IF [ [ ( 1 + AVF \times PPAG ) \times \frac{( BHP + OBSF ) - Pressure Test}{0.05195 \times TVD} ] - PPAG > Min ( {P}_{1} , {P}_{2} ) {P}_{3} , Min ( {P}_{1} , {P}_{2} ) ] , IF [ ( 1 + AVF \times PPAG ) \times \frac{( BHP + OBSF ) - Pressure Test}{0.05195 \times TVD} ] - PPAG > Min ( {P}_{1} , {P}_{2} ) {P}_{3} , Min ( {P}_{1} , {P}_{2} ) ] , \frac{BHTP + Friction - Max Treating Pressure Desired}{0.05195 \times TVD} \times ( 1 + AVF \times PPAG ) - PPAG = {P}_{1} , \frac{{Q}_{4}}{1 + AVF \times PPAG} , \frac{\frac{{Q}_{4}}{1 + AVF \times PPAG} \times \frac{{P}_{2} - {P}_{3}}{{P}_{3} - {P}_{1}}}{1 + \frac{{P}_{2} - {P}_{3}}{{P}_{3} - {P}_{1}}} & EQ . 1 \\ {Q}_{2} = {Q}_{3} - {Q}_{1} & EQ . 2 \\ {Q}_{3} = \frac{{Q}_{4}}{1 + AVE \times PPAG} & EQ . 3\end{matrix}$$

Where Q1 is the flow rate of the first fluid, Q2 is the flow rate of the second fluid, Q3 is the flow rate of the mixture of the first fluid and the second fluid, Q4 is the flow rate of the slurry, ρ1 is the density of the first fluid, ρ2 is the density of the second fluid, ρ3 is the density of the fluid mixture, ρ4 is the density of the slurry, IF is a conditional statement of acceptance, BHTP is the bottom hole treating pressure, friction is the friction in the treating path, TVD is True vertical Depth of the treated interval, BHP is the bottom hole pressure, AVF is the absolute volume factor of the additive, PPAG is the pounds of additive added per gallon of clean fluid, OSBF is the overbalance safety factor, pressure test is the pressure that an equipment is tested at or pressure release valves setting, and max treating pressure desired is the max treating pressured desired based on a specific job operation.

At block S404, an amount of additive to add to the mixture is determined based on the one or more characteristics. At block S406, a volume of the first fluid, which when mixed with the second fluid, forms a mixture having a ratio of the first fluid to the second fluid, is released. In the embodiment of FIG. 2A, processors of controller 184 determine the ratio of the first fluid and the second fluid, and request valve 243 to release a volume of the first fluid, which when mixed with the second fluid, forms a mixture having the determined ratio. In the embodiment of FIG. 2C, a chemical additive is first added to the first fluid before the first fluid is released by valve 243.

At block S408, the first fluid is mixed with the second fluid to form the mixture having the ratio of the first fluid to the second fluid. FIG. 2A, for example, illustrates mixing first fluid and second fluid with fluid mixer 245 to form a fluid mixture of the first fluid and the second fluid. In some embodiments, a chemical additive is also added to the fluid mixture. FIG. 2B, for example, illustrates mixing the first fluid and the second fluid to form a fluid mixture and adding chemical additives to the fluid mixture. FIG. 2C, for example, illustrates first adding a chemical additive to the first fluid then mixing the first fluid with the second fluid to form a mixture of the first fluid and the second fluid.

At block S410, the determined amount of additive is added to the mixture having the ratio of the first fluid to the second fluid. In the embodiment of FIGS. 2A-2C, the processors of controller 184 request additive dispenser 246 to release the determined amount of additive. In some embodiments, the processors of controller 184 also determine the type of additive to dispense and request additive dispenser 246 to dispense the determined amount of the determined type of additive. In some embodiments, the processors of controller 184 also determine to simultaneously release multiple types of additives, and request additive dispenser 246 to dispense the determined amounts of the multiple types of additives.

At block S412, a determination of whether the fluid mixing operation is complete is made.

The process returns to block S402 if the processors determine to continue to mix the first fluid with the second fluid and the operations performed at blocks S402, S404, S406, S408, and S410 are repeated. Moreover, sensors described herein continue to obtain up-to-date measurements of the fluid flow rate and density of the first fluid, the fluid flow rate and density of the second fluid, the fluid flow rate and density of the fluid mixture, properties of the additive, fluid flow rate and density of the slurry, properties of conveyance 119 and wellbore 106, as well as other characteristics of the first fluid, the second fluid, the fluid mixture, the slurry, downhole properties, and operational parameters. The processors incorporate the up-to-date measurements at each step of the operations described herein and vary operations performed at blocks S404, S406, S408, and S410 based on changes to previously-obtained measurements to continuously provide a desired amount of slurry having a desired density downhole and to comply with operational parameters described herein. Alternatively, at block S412, if a determination that the fluid mixing operation described herein is complete, then the operation ends.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/processes may be performed in parallel or out of sequence, or combined into a single step/process. The scope of the claims is intended to broadly cover the disclosed embodiments and any such modification. Further, the following clauses represent additional embodiments of the disclosure and should be considered within the scope of the disclosure.

Clause 1, a method to dynamically adjust a density of a fluid mixture, the method comprising: obtaining data indicative of one or more characteristics of a mixture of a first fluid having a first density and a second fluid having a second density that is less than the first density; determining, based on the one or more characteristics, an amount of additive to add to the mixture;

releasing a volume of the first fluid, which when mixed with the second fluid, forms a mixture having a ratio of the first fluid to the second fluid, wherein the ratio of the first fluid to the second fluid is based on the amount of additive to add to the mixture; mixing the first fluid with the second fluid to form the mixture having the ratio of the first fluid to the second fluid; and adding the determined amount of additive to the mixture having the ratio of the first fluid to the second fluid.

Clause 2, the method of clause 1, further comprising: periodically obtaining data indicative of the one or more characteristics of the mixture; and varying the amount of additive to add to the mixture based on one or more updates to the one or more characteristics of the mixture.

Clause 3, the method of clause 2, further comprising periodically determining a flow rate of the mixture, wherein the flow rate of the mixture is a characteristic of the one or more characteristics of the mixture, and wherein varying the amount of additive to add to the mixture comprises varying the amount of additive to add to the mixture based on the flow rate of the mixture.

Clause 4, the method of clauses 2 or 3, further comprising periodically determining a density of the mixture, wherein the density of the mixture is a characteristic of the one or more characteristics of the mixture, and wherein varying the amount of additive to add to the mixture comprises varying the amount of additive to add to the mixture based on the density of the mixture.

Clause 5, the method of any of clauses 2-4, further comprising periodically determining a flow rate of a slurry containing the mixture and the additive, wherein the flow rate of the slurry is a characteristic of the one or more operating characteristics of the mixture, and wherein varying the amount of additive to add to the mixture comprises varying the amount of additive to add to the mixture based on the flow rate of the slurry.

Clause 6, the method of any of clauses 2-5, further comprising periodically determining one or more safety parameters associated with the mixture, and wherein varying the amount of additive to add to the mixture comprises varying the amount of additive to add to the mixture to comply with the one or more safety parameters associated with the mixture.

Clause 7, the method of any of clauses 2-6, further comprising periodically adjusting the ratio of the first fluid to the second fluid based on the amount of additive to add to the mixture.

Clause 8, the method of any of clauses 2-7, further comprising determining a desired ratio of the first fluid to the second fluid, wherein the desired ratio of the first fluid to the second fluid is a characteristic of the one or more characteristics of the mixture, and wherein varying the amount of additive to add to the mixture comprises varying the amount of additive to add to the mixture based on an update to the desired ratio of the first fluid to the second fluid.

Clause 9, the method of any of clauses 2-8, further comprising selecting, based on the one or more characteristics of the mixture, a type of additive from one or more types of additives, wherein determining the amount of additive to add to the mixture comprises determining the amount of the selected type of additive to add to the mixture, and wherein adding the determined amount of additive to the mixture comprises adding the determined amount of the type of additive to the mixture.

Clause 10, the method of any of clauses 1-9, further comprising; obtaining data indicative of one or more operating parameters; and varying the amount of additive to comply with the one or more operating parameters.

Clause 11, the method of clause 10, further comprising varying the ratio of the first fluid to the second fluid to comply with the one or more operating parameters.

Clause 12, the method of any of clauses 1-11, further comprising adding chemical additive to the mixture before the additive is added to the mixture, wherein determining the amount of additive to add to the mixture comprises determining the amount of additive to add to the mixture based on the amount of the chemical additive added to the mixture.

Clause 13, the method of any of clauses 1-12, further comprising adding chemical additive to the first fluid before the first fluid is mixed with the second fluid, wherein determining the amount of additive to add to the mixture comprises determining the amount of additive to add to the mixture based on the amount of the chemical additive added to the first fluid

Clause 14, the method of clauses 1-13, further comprising adding a third fluid to the mixture of the first fluid and the second fluid, wherein a ratio of the first fluid to the second and third fluids is a characteristic of the one or more characteristics of the mixture, wherein determining the amount of additive to add to the mixture comprises determining the amount of additive to add to the mixture based on the ratio of the first fluid to the second and third fluids.

Clause 15, a fluid mixing system, comprising: a storage medium; and one or more processors operable to: obtain data indicative of one or more characteristics of a mixture of a first fluid having a first density and a second fluid having a second density that is less than the first density; determine, based on the one or more characteristics, an amount of additive to add to the mixture; release a volume of the first fluid, which when mixed with the second fluid, forms a mixture having a ratio of the first fluid to the second fluid, wherein the ratio of the first fluid to the second fluid is based on the amount of additive to add to the mixture; mix the first fluid with the second fluid to form the mixture having the ratio of the first fluid to the second fluid; and add the determined amount of additive to the mixture having the ratio of the first fluid to the second fluid.

Clause 16, the fluid mixing system of clause 15, wherein the one or more processors are further operable to: periodically obtain data indicative of the one or more characteristics of the mixture; and vary the amount of additive to add to the mixture based on one or more updates to the one or more characteristics of the mixture.

Clause 17, the fluid mixing system of clauses 15 or 16, wherein the one or more processors are further operable to periodically determine a flow rate of the mixture, wherein the flow rate of the mixture is a characteristic of the one or more characteristics of the mixture, and wherein the one or more processors are further operable to periodically vary the amount of additive to add to the mixture based on the flow rate of the mixture.

Clause 18, the fluid mixing system of any of clauses 15-17, wherein the one or more processors are further operable to periodically determine a flow rate of a slurry containing the mixture and the additive, wherein the flow rate of the slurry is a characteristic of the one or more characteristics of the mixture, and wherein the one or more processors are further operable to periodically vary the amount of additive to add to the mixture based on the flow rate of the slurry.

Clause 19, a non-transitory machine-readable medium comprising instructions stored therein, which when executed by one or more processors, cause the one or more processors to perform operations comprising: obtaining data indicative of one or more characteristics of a mixture of a first fluid having a first density and a second fluid having a second density that is less than the first density; determining, based on the one or more characteristics, an amount of additive to add to the mixture; releasing a volume of the first fluid, which when mixed with the second fluid, forms a mixture having a ratio of the first fluid to the second fluid, wherein the ratio of the first fluid to the second fluid is based on the amount of additive to add to the mixture; mixing the first fluid with the second fluid to form the mixture having the ratio of the first fluid to the second fluid; and adding the determined amount of additive to the mixture having the ratio of the first fluid to the second fluid.

Clause 20, the non-transitory machine-readable medium of claim 19, wherein the instructions when executed by one or more processors, cause the one or more processors to perform operations comprising: periodically obtaining data indicative of the one or more characteristics of the mixture; and varying the amount of additive to add to the mixture based on one or more updates to the one or more characteristics of the mixture.

Unless otherwise specified, any use of any form of the terms “connect,” “engage,” “couple,” “attach,” or any other term describing an interaction between elements in the foregoing disclosure is not meant to limit the interaction to direct interaction between the elements and may also include indirect interaction between the elements described. As used herein, the singular forms “a”, “an,” and “the” are intended to include the plural forms as well, unless the context clearly indicates otherwise. Unless otherwise indicated, as used throughout this document, “or” does not require mutual exclusivity. It will be further understood that the terms “comprise” and/or “comprising,” when used in this specification and/or in the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

It should be apparent from the foregoing that embodiments of an invention having significant advantages have been provided. While the embodiments are shown in only a few forms, the embodiments are not limited but are susceptible to various changes and modifications without departing from the spirit thereof.

1. A method to dynamically adjust a density of a fluid mixture, the method comprising:
obtaining data indicative of one or more characteristics of a mixture of a first fluid having a first density and a second fluid having a second density that is less than the first density;
determining, based on the one or more characteristics, an amount of additive to add to the mixture;
releasing a volume of the first fluid, which when mixed with the second fluid, forms a mixture having a ratio of the first fluid to the second fluid, wherein the ratio of the first fluid to the second fluid is based on the amount of additive to add to the mixture;
mixing the first fluid with the second fluid to form the mixture having the ratio of the first fluid to the second fluid; and
adding the determined amount of additive to the mixture having the ratio of the first fluid to the second fluid.

2. The method of claim 1, further comprising:
periodically obtaining data indicative of the one or more characteristics of the mixture; and
varying the amount of additive to add to the mixture based on one or more updates to the one or more characteristics of the mixture.

3. The method of claim 2, further comprising periodically determining a flow rate of the mixture, wherein the flow rate of the mixture is a characteristic of the one or more characteristics of the mixture, and wherein varying the amount of additive to add to the mixture comprises varying the amount of additive to add to the mixture based on the flow rate of the mixture.

4. The method of claim 2, further comprising periodically determining a density of the mixture, wherein the density of the mixture is a characteristic of the one or more characteristics of the mixture, and wherein varying the amount of additive to add to the mixture comprises varying the amount of additive to add to the mixture based on the density of the mixture.

5. The method of claim 2, further comprising periodically determining a flow rate of a slurry containing the mixture and the additive, wherein the flow rate of the slurry is a characteristic of the one or more operating characteristics of the mixture, and wherein varying the amount of additive to add to the mixture comprises varying the amount of additive to add to the mixture based on the flow rate of the slurry.

6. The method of claim 2, further comprising periodically determining one or more safety parameters associated with the mixture, and wherein varying the amount of additive to add to the mixture comprises varying the amount of additive to add to the mixture to comply with the one or more safety parameters associated with the mixture.

7. The method of claim 2, further comprising periodically adjusting the ratio of the first fluid to the second fluid based on the amount of additive to add to the mixture.

8. The method of claim 2, further comprising determining a desired ratio of the first fluid to the second fluid, wherein the desired ratio of the first fluid to the second fluid is a characteristic of the one or more characteristics of the mixture, and wherein varying the amount of additive to add to the mixture comprises varying the amount of additive to add to the mixture based on an update to the desired ratio of the first fluid to the second fluid.

9. The method of claim 2, further comprising selecting, based on the one or more characteristics of the mixture, a type of additive from one or more types of additives, wherein determining the amount of additive to add to the mixture comprises determining the amount of the selected type of additive to add to the mixture, and wherein adding the determined amount of additive to the mixture comprises adding the determined amount of the type of additive to the mixture.

10. The method of claim 1, further comprising;
obtaining data indicative of one or more operating parameters; and
varying the amount of additive to comply with the one or more operating parameters.

11. The method of claim 10, further comprising varying the ratio of the first fluid to the second fluid to comply with the one or more operating parameters.

12. The method of claim 1, further comprising adding a chemical additive to the mixture before the additive is added to the mixture, wherein determining the amount of additive to add to the mixture comprises determining the amount of additive to add to the mixture based on the amount of the chemical additive added to the mixture.

13. The method of claim 1, further comprising adding a chemical additive to the first fluid before the first fluid is mixed with the second fluid, wherein determining the amount of additive to add to the mixture comprises determining the amount of additive to add to the mixture based on the amount of the chemical additive added to the first fluid.

14. The method of claim 1, further comprising adding a third fluid to the mixture of the first fluid and the second fluid, wherein a ratio of the first fluid to the second and third fluids is a characteristic of the one or more characteristics of the mixture, wherein determining the amount of additive to add to the mixture comprises determining the amount of additive to add to the mixture based on the ratio of the first fluid to the second and third fluids.

15. A fluid mixing system, comprising:
a storage medium; and
one or more processors operable to:
obtain data indicative of one or more characteristics of a mixture of a first fluid having a first density and a second fluid having a second density that is less than the first density;
determine, based on the one or more characteristics, an amount of additive to add to the mixture;
release a volume of the first fluid, which when mixed with the second fluid, forms a mixture having a ratio of the first fluid to the second fluid, wherein the ratio of the first fluid to the second fluid is based on the amount of additive to add to the mixture;
mix the first fluid with the second fluid to form the mixture having the ratio of the first fluid to the second fluid; and
add the determined amount of additive to the mixture having the ratio of the first fluid to the second fluid.

16. The fluid mixing system of claim 15, wherein the one or more processors are further operable to:
periodically obtain data indicative of the one or more characteristics of the mixture; and
vary the amount of additive to add to the mixture based on one or more updates to the one or more characteristics of the mixture.

17. The fluid mixing system of claim 15, wherein the one or more processors are further operable to periodically determine a flow rate of the mixture, wherein the flow rate of the mixture is a characteristic of the one or more characteristics of the mixture, and wherein the one or more processors are further operable to periodically vary the amount of additive to add to the mixture based on the flow rate of the mixture.

18. The fluid mixing system of claim 15, wherein the one or more processors are further operable to periodically determine a flow rate of a slurry containing the mixture and the additive, wherein the flow rate of the slurry is a characteristic of the one or more characteristics of the mixture, and wherein the one or more processors are further operable to periodically vary the amount of additive to add to the mixture based on the flow rate of the slurry.

19. A non-transitory machine-readable medium comprising instructions stored therein, which when executed by one or more processors, cause the one or more processors to perform operations comprising:
obtaining data indicative of one or more characteristics of a mixture of a first fluid having a first density and a second fluid having a second density that is less than the first density;
determining, based on the one or more characteristics, an amount of additive to add to the mixture;
releasing a volume of the first fluid, which when mixed with the second fluid, forms a mixture having a ratio of the first fluid to the second fluid, wherein the ratio of the first fluid to the second fluid is based on the amount of additive to add to the mixture;
mixing the first fluid with the second fluid to form the mixture having the ratio of the first fluid to the second fluid; and
adding the determined amount of additive to the mixture having the ratio of the first fluid to the second fluid.

20. The non-transitory machine-readable medium of claim 19, wherein the instructions when executed by one or more processors, cause the one or more processors to perform operations comprising:
periodically obtaining data indicative of the one or more characteristics of the mixture; and
varying the amount of additive to add to the mixture based on one or more updates to the one or more characteristics of the mixture.
